(19) United States
(12) Patent Application Publication
(10) Pub. No.: US 2019/0373022 A1
(43) Pub. Date: Dec. 5, 2019

(54) ENHANCED FRONT PANEL SECURITY VIA A CLOUD NETWORK MANAGEMENT SYSTEM

(71) Applicant: Hewlett Packard Enterprise Development LP, Houston, TX (US)

(72) Inventors: YASHAVANTHA NAGARAJU, Bangalore (IN); NITIN SINGLA, Bangalore (IN); PRAVEEN RAMESH GANJAM, Bangalore (IN)

(21) Appl. No.: 16/109,668

(22) Filed: Aug. 22, 2018

(30) Foreign Application Priority Data
Jun. 1, 2018 (IN) 201841020694

(51) Int. Cl. H04L 29/06

(52) U.S. Cl. CPC H04L 63/205

(57) ABSTRACT

The disclosure relates to enhanced front panel security (“FPS”) of network devices via a cloud network management system (“NMS”). The system may remotely disable a manually actuated control function of a user interface member of one or more network devices managed by the cloud NMS. The system may remotely disable the manually-actuated control function such that when the user interface member is manually actuated, the control function is not performed. In some instances, whether or not the manually actuated control function is enabled or disabled may be stored as a configuration setting of the network device. In these instances, the default may be to omit the configuration setting from a running configuration of the network device. The system may enable or disable inclusion of the configuration setting in the running configuration. Thus, display of the configuration setting may be enabled or disabled as well.

### CROSS-REFERENCE TO RELATED APPLICATIONS

The present application claims priority to Indian Patent Application No. 201841020694, filed on Jun. 1, 2018, which is incorporated herein by reference in its entirety.

### FIELD OF THE DISCLOSURE

The disclosures relates to enhancing front panel security features via a cloud network management system that remotely disables or enables configuration settings that impact the security of network devices.

### BACKGROUND OF THE DISCLOSURE

Reducing the Operational expenditure or also termed as OPEX is a major concern for any organization. By providing enhanced security options via a cloud network management system (NMS), it has a huge benefit in terms of OPEX reduction for an organization considering the way malicious users can literally access the box, such as a network device, (both physically and the console used to access the network device) and making it unusable for future use.

Some network devices provide an ability to reset a password, reboot the device, or otherwise revert configuration settings to default states. For example, some devices have a “clear” button that when pressed for a predetermined time resets the password to a default setting. This was intended as a way to regain entry to a network device by legitimate personnel. This was considered reasonably secure because physical access to the device was required to execute this function and because physical access to network devices was typically restricted. However, in many instances, network devices are not secured from physical access. Malicious users having physical access to the device may compromise it.

These and other drawbacks exist with conventional network devices and management systems.

### SUMMARY OF THE DISCLOSURE

The disclosure addressing these and other drawbacks relates to providing enhanced front panel security (“FPS”) of network devices via a cloud network management system (“NMS”). The system may remotely disable a manually actuated control function of a user interface member of one or more network devices managed by the cloud NMS. For instance, network devices may include one or more user interface members that, when manually actuated, provide certain control functions. These control functions may include, without limitation, a reboot function that reboots the network device, a password reset function that resets access passwords to a factory default password, a configuration reset function that resets device configurations to default settings, and/or other functions that control a functionality of the network device. In some instances, a user interface member may be actuated in combination with at least one other user interface member to trigger the manually-actuated control function. In some instances, particular types of manual actuations such as a press-and-hold actuation may trigger the manually-actuated control function.

The system may remotely interface with the network device to disable the manually-actuated control function such that when the user interface member is manually actuated, the control function is not performed. In this manner, this function of the network device may be remotely controlled instead of requiring a user to physically control this function. In some instances, whether or not the manually actuated control function is enabled or disabled may be stored as a configuration setting of the network device (this configuration setting will be referred to as a “FPS configuration setting”). In these instances, the default may be to omit the FPS configuration setting from a running configuration of the network device. The running configuration is a set of network device configuration settings displayed responsive to a request to view these settings. Not all network device configuration settings are included in the running configuration. The system may enable or disable inclusion of the configuration setting relating to the manually actuated control function in the running configuration. Whether to enable or disable such inclusion will also be referred to as the “display-in-config function” and the associated configuration setting that controls this will also be referred to as the “display-in-config setting.” As such, the system may remotely control whether the network device displays the FPS configuration.

For example, the system may receive a remotely-initiated request to disable a manually-actuated control function of a user interface member of one or more network devices. The request may be initiated remotely from the one or more network devices via a network. For example, the request may be initiated from a remote management computer via a cloud NMS. It should be noted that the request may be a request to enable, instead of disable, a FPS configuration setting.

The system may transmit a command to each of the one or more network devices. The command may cause the manually-actuated control function of the user interface member of the one or more network devices to be disabled from being manually actuated. For example, the cloud NMS may make a web service request, e.g., via an API call, to invoke a command that resolves the request. The command may cause the one or more network devices to disable their respective FPS configuration setting.

The system may maintain remote control of the manually-actuated control function via a cloud-based NMS. For example, the cloud-based NMS may maintain control by being able to re-enable the manually-actuated control function as well as remotely monitor the FPS configuration setting.

In some instances, remote control may be maintained by preventing local updates to the FPS configuration setting and/or the display-in-config setting. For instance, if the FPS configuration setting and/or the display-in-config setting has been remotely modified, the network device may be configured to deny local updates to either or both settings. In this manner, a remote network administrator or others may maintain control over the network device.

In some implementations, instead of or in addition to a request to enable or disable the FPS configuration setting, the system may receive a request to enable or disable a display-in-config setting that controls whether or not to list the FPS configuration setting along with the running configuration of the one or more network devices. In these implementations, the system may generate and transmit a command that toggles this display-in-config setting as requested. In some of these implementations, a corresponding network device may include or omit the FPS configuration setting from the running configuration depending on the value of the display-in-config setting, as controlled by the cloud NMS.

A network device may accordingly execute (or not execute) a manually-actuated control function depending on the FPS configuration setting set by the cloud NMS. Alternatively or additionally, the network device may provide (or not provide) the FPS configuration setting with the running configuration of the device depending on a display-on-config configuration setting, which may also be set by the cloud NMS.

For example, the network device may receive a configuration listing request. For example, the configuration listing request may request the configuration settings of the network device. The network device may determine whether a display-in-config setting has been enabled. The display-in-config setting may control whether or not an FPS configuration setting should be displayed along with the running configuration of the network device.

The network device may add the value of the FPS configuration setting to the running configuration if the display-in-config setting is enabled. If the display-in-config setting is not enabled, then the value of the FPS configuration setting is not added to the running configuration. The network device may display the running configuration in response to the configuration listing request. In this manner, not only may one or more manually-actuated control functions of the network device be controlled by a cloud NMS, whether or not to display this setting may be controlled by the cloud NMS as well.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of The disclosure. As used in the specification and in the claims, the singular form of “a”, “an”, and “the” include plural referents unless the context clearly dictates otherwise.

### BRIEF DESCRIPTION OF THE DRAWINGS

FIG. 1 illustrates an example of a system for providing enhanced front panel security of network devices via a cloud network management system, according to an implementation of the disclosure.

FIG. 2 illustrates a schematic diagram of local and remote control of an example of a network device with user interface members each having a manually-actuated control function that is remotely secured by a cloud network management system, according to an implementation of the disclosure.

FIG. 3 illustrates an example of a process of disabling a manually actuated control function of one or more network devices via a cloud network management system, according to an implementation of the disclosure.

FIG. 4 illustrates an example of a process of controlling the listing of an FPS configuration setting that enables or disables a manually actuated control function of a network device, according to an implementation of the disclosure.

FIG. 5 depicts a block diagram of an example computer system 500 in which any of the embodiments described herein may be implemented.

### DETAILED DESCRIPTION OF THE DISCLOSURE

The disclosure described herein relates to a system and method of providing enhanced front panel security (“FPS”) of network devices via a cloud network management system (“NMS”). The system may remotely disable a manually actuated control function of a user interface member of one or more network devices managed by the cloud NMS. For instance, network devices may include user interface members that, when manually actuated, provide certain control functions. The term “manually-actuated control function” refers to a control function that is invoked upon manual actuation of a user interface member. These control functions may include, without limitation, a reboot function that reboots the network device, a password reset function that resets access passwords to a factory default password, a configuration reset function that resets device configurations to default settings, and/or other functions that control a functionality of the network device. In some instances, a user interface member may be actuated in combination with at least one other user interface member to trigger the manually-actuated control function. In some instances, particular types of manual actuations such as a press-and-hold actuation may trigger the manually-actuated control function.

The system may remotely interface with the network device to disable the manually-actuated control function such that when the user interface member is manually actuated, the control function is not performed. In this manner, this function of the network device may be remotely controlled instead of requiring a user to physically control this function. In some instances, whether or not the manually actuated control function is enabled or disabled may be stored as a configuration setting of the network device (this configuration setting will be referred to as a “FPS configuration setting”). In these instances, the default may be to omit the FPS configuration setting from a running configuration of the network device. The running configuration is a set of network device configuration settings displayed responsive to a request to view these settings. Not all network device configuration settings are included in the running configuration. The system may enable or disable inclusion of the configuration setting relating to the manually actuated control function in the running configuration. Whether to enable or disable such inclusion will also be referred to as the “display-in-config function” and the associated configuration setting that controls this will also be referred to as the “display-in-config setting.” As such, the system may remotely control whether the network device displays the FPS configuration.

The disclosure describes management of FPS functions for illustration and not limitation. Other types of functions of network devices may be remotely controlled as would be apparent based on the disclosure.

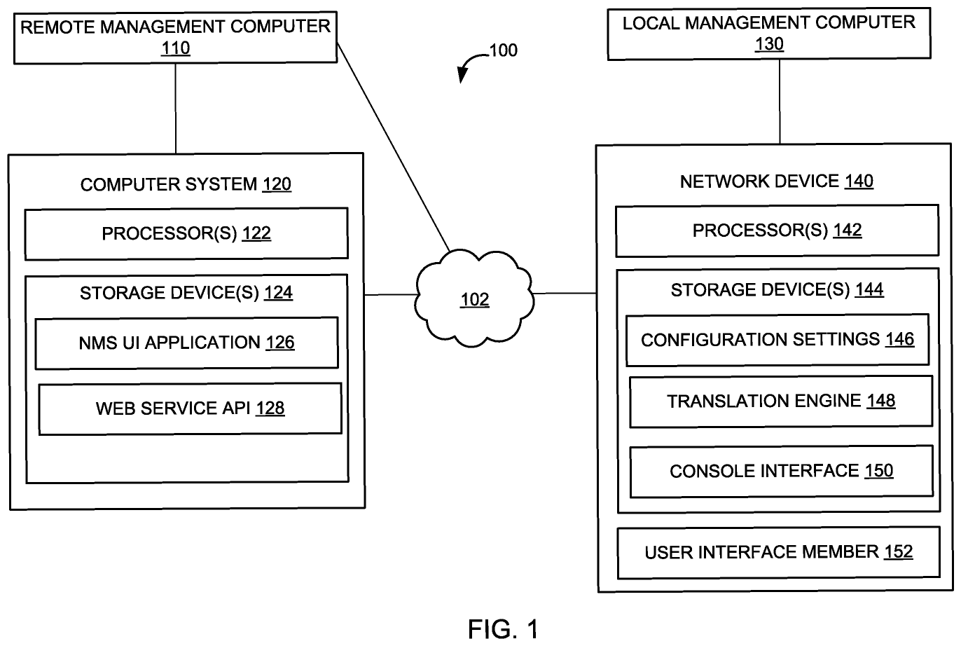

FIG. 1 illustrates an example of a system 100 for providing enhanced front panel security of network devices via a cloud network management system, according to an implementation of the disclosure. System 100 may include a local management computer 110, a network management system 120, a local management computer 130, one or more network devices 140, and/or other components. Management computer 110 may interface via a network with the NMS 120 to issue management commands to the one or more network devices 140. As such, NMS 120 may be configured as a cloud-based NMS that is capable of remotely providing management functions via a network to simultaneously control one or more (and typically though not necessarily multiple) network devices.

NMS 120 may include one or more processors 122 (also interchangeably referred to herein as processors 122, processor(s) 122, or processor 122 for convenience), one or more storage devices 124 (which may store an NMS user interface (“UP”) application 126 and a web service Application Programming Interface (“API”) 128), and/or other components. Processors 122 may be programmed by one or more computer program instructions. For example, processors 122 may be programmed by NMS UI application 126, web service API 128, and/or other instructions. As used herein, for convenience, the various instructions will be described as performing an operation, when, in fact, the various instructions program the processors 122 (and therefore NMS 120) to perform the operation.

NMS user interface (“UI”) application 126 may generate a UI for managing one or more network devices. The UI may be provided to a remote management computer 110 so that a user may remotely manage one or more network devices 140 through the UI. For instance, the UI may include a graphical UI that includes input options for a user to enable or disable the manually actuated control functions of one or more network devices 140. The UI may group the network devices 140 according to their type (such as network switch groups, access point groups, etc.), location, and/or other grouping criteria so that groups of network devices may be managed together based on a single input. For example, the UI may provide an input for toggling the FPS configuration setting and/or the display-in-config setting. The input may be used to enable or disable these settings for an entire group. In some instances, the UI may provide search functionality to search for specific network devices or specific types of network devices. In some instances, the UI may include inputs options to enable or disable inclusion of the FPS configuration setting in the running configuration of a network device 140.

Management input and an identification of one or more network devices 140 from the UI may be received at the NMS UI application 126 and passed to the web service API 128. The web service API 128 may be configured as a Representational State Transfer (“REST”) API. In these instances, a REST API call may be implemented. For example, the REST API call may include:
POST [rel. path] {“enable”: “yes/no”},
   where “rel. path” denotes a relative path, which represents a location of a file or directory relative to another file or directory, for execution. For example, this call may be used to toggle on/off (in other words enable—“yes” or disable—“no”) the FPS configuration setting in which case the rel. path may resolve to a location associated with controlling the FPS configuration setting. In another example, this call may be used to toggle on/off (in other words enable—“yes” or disable—“no”) permitting the value of the FPS configuration setting is listed with the running configuration of the network device, in which case the rel. path may resolve to a location associated with controlling this configuration setting.

The web service API 128 may interface with the one or more network devices 140 and transmit a command to enable or disable the FPS configuration setting and/or inclusion of the FPS configuration setting into the running configuration based on the UI input, which may be received via the REST API call.

Network device 140 may include one or more processors 142 (also interchangeably referred to herein as processors 142, processor(s) 142, or processor 142 for convenience), one or more storage devices 144 (which may store one or more configuration settings 146, a translation engine 148, and a console interface 150), one or more user interface members 152, and/or other components. Processors 142 may be programmed by one or more computer program instructions. For example, processors 142 may be programmed by the translation engine 148, the console interface 150, and/or other instructions. As used herein, for convenience, the various instructions will be described as performing an operation, when, in fact, the various instructions program the processors 142 (and therefore network device 140) to perform the operation. Network device 140 may be configured as a switch, a router, a network controller, an access point, a gateway, and/or other type of network device that forms part of a network of computers.

The one or more configuration settings 146 may include operational settings used by the network device 140. The configuration settings 146 may be stored as a configuration file (commonly referred to as a “config file”). The config file may include the FPS configuration setting, a setting that enables or disables listing the FPS configuration setting in the running configuration, and/or other configuration settings of the network device 140.

The network device 140 may implement a translation engine 148. The translation engine 148 may manage the config file and enables the FPS configuration setting and/or the display-in-config feature. The translation engine 148 may be implemented as an XLATE engine. An XLATE engine may generally translate first data to second data. For example, the XLATE engine may include a lookup table that maps the first data to the second data. The XLATE engine may therefore be used to manage configuration settings using the lookup table by mapping first data such as a configuration setting (in particular, the FPS configuration setting or the display-in-config setting) with second data such as a value of the configuration setting (in particular, either “enable” or “disable”; or 1 for enable and 0 for disable).

The network device 140 may implement a console interface 150, which may provide a UI for locally managing the network device. The UI may include a graphical UI. Alternatively or additionally, the UI may include a command-line interface, or CLI 151. In some instances, the console interface may implement a new command-line:
“switch(config)# display-in-config”
   In this example, the display-in-config setting may be toggled from the CLI 151. The FPS configuration setting may similarly be controlled from the CLI 151 as well. In some instances, local control of the FPS configuration setting and/or the display-in-config setting may be overridden by the remote control provided by the cloud NMS (the computer system 120, also referred to as a cloud-based NMS). This may occur, for example, by a configuration setting in the config file that specifies whether remote control of these settings were made. If so, local control of the FPS configuration setting and/or the display-in-config setting may be prohibited. In some instances, remote control of these settings may permit local control, in which case the configuration setting may not be set. As such, a network administrator or other user may use the cloud NMS to control the FPS configuration setting and/or the display-in-config setting as well as whether local control of these settings is permitted.

The one or more user interface members 152 may each include user interface members that may be manually actuated to control a function. For example, the user interface member 152 may include, without limitation, a button, a switch, a rocker panel, and/or other member that may be manually actuated to control a function. At least some of the user interface members 152 when manually actuated may control a manually-actuated control function. An FPS configuration setting may enable or disable one or more of such manually-actuated control functions.

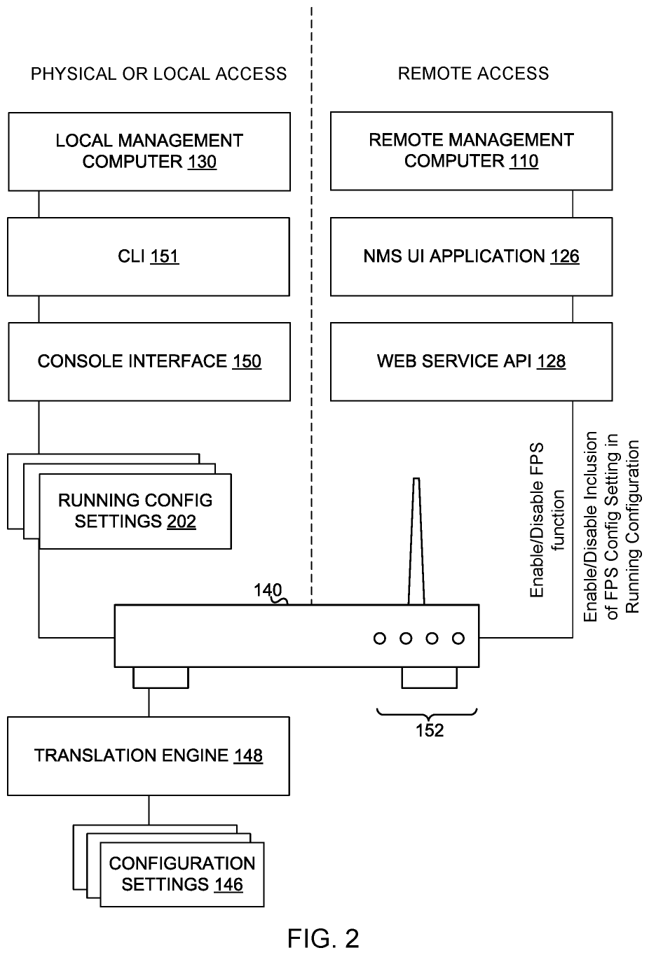

FIG. 2 illustrates a schematic diagram 200 of local and remote control of an example of a network device 140 having user interface members 152 each having a manually-actuated control function that is remotely secured by a cloud network management system, according to an implementation of the disclosure. Local control may be facilitated by the console interface 150, which may provide the CLI 151 or other UI for the local management computer 130 as described above. As such, the console interface 150 provides physical or local access and control to the network device 140 to the local management computer 130, which may be physically connected to the network device 140 or otherwise locally connected to the network device 140 via, for example, a local area network. Through the console interface 150, the local management computer 130 may view the running config settings 202 that form the running configuration of the network device 140. The running configuration is a set of network device configuration settings, including the running config settings 202, displayed responsive to a request to view these settings. Not all network device configuration settings are included in the running configuration. The system may enable or disable inclusion of the configuration setting relating to the manually actuated control function in the running configuration. Examples of running config settings 202 include, without limitation:
front-panel-security display-in-config
front-panel-security password-clear reset-on-clear
no front-panel-security factory-reset

In the above example, the “display-in-config” setting is enabled, the password-clear and reset-on-clear settings are enabled (enabling or toggling on the FPS configuration setting) and the factory-reset function is disabled. Different running config settings 202 may be included as well.

As also described above, remote control may be facilitated by the web service API 128, which provides remote access from the remote management computer 110 to the network device 140 via the NMS UI application 126. For example, the FPS configuration setting and/or the display-in-config setting may be controlled via the REST API call.

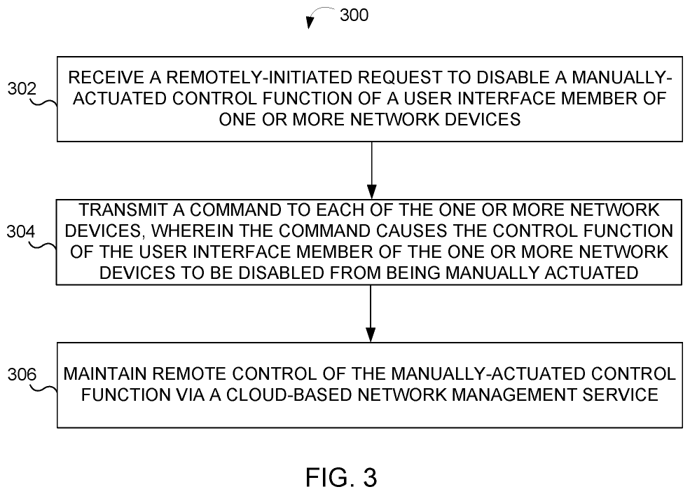

FIG. 3 illustrates an example of a process 300 of disabling a manually actuated control function of one or more network devices via a cloud network management system, according to an implementation of the disclosure.

In an operation 302, process 300 may include receiving a remotely-initiated request to disable a manually-actuated control function of a user interface member 152 of one or more network devices 140. The request may be initiated remotely from the one or more network devices 140 via a network, such as network 102. For example, the request may be initiated from a remote management computer 110 via a cloud NMS such as computer system 120. It should be noted that the request may be a request to enable, instead of disable, a FPS configuration setting.

In an operation 304, process 300 may include transmitting a command to each of the one or more network devices, wherein the command causes the manually-actuated control function of the user interface member of the one or more network devices to be disabled from being manually actuated. For example, the cloud NMS may make a webservice API call to invoke a command that resolves the request. The command may cause the one or more network devices to disable their respective FPS configuration setting.

In an operation 306, process 300 may include maintaining remote control of the manually-actuated control function via a cloud-based NMS. For example, the cloud-based NMS maintain control by being able to re-enable the manually-actuated control function as well as remotely monitor the FPS configuration setting.

In some instances, remote control may be maintained by preventing local updates to the FPS configuration setting and/or the display-in-config setting. For instance, if the FPS configuration setting and/or the display-in-config setting has been remotely modified, the network device may be configured to deny local updates to either or both settings. In this manner, a remote network administrator or others may maintain control over the

In some implementations, instead of or in addition to a request to enable or disable the FPS configuration setting, process 300 may include receiving a request to enable or disable a display-in-config setting that controls whether or not to list the FPS configuration setting along with the running configuration of the one or more network devices 140. In these implementations, process 300 may generate and transmit a command that toggles this display-in-config setting as requested. In some of these implementations, a corresponding network device 140 may include or omit the FPS configuration setting from the running configuration depending on the value of the display-in-config setting, as controlled by the process 300.

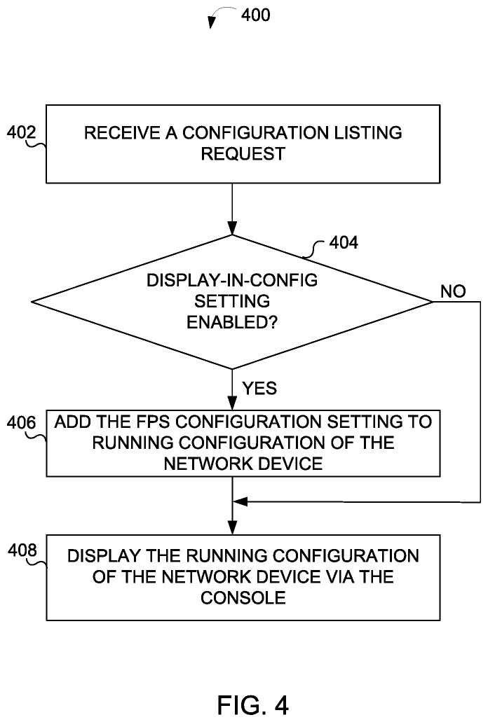

FIG. 4 illustrates an example of a process 400 of controlling the listing of an FPS configuration setting that enables or disables a manually actuated control function of a network device 140, according to an implementation of the disclosure.

In an operation 402, process 400 may include receiving a configuration listing request. For example, the configuration listing request may request the configuration settings of a network device 140.

In an operation 404, process 400 may include determining whether a display-in-config setting has been enabled. The display-in-config setting may control whether or not an FPS configuration setting should be displayed along with a running configuration of the network device 140. If the display-in-config setting has been enabled, process 400 proceeds to operation 406. On the other hand, if the display-in-config setting has been disabled, process 400 proceeds to operation 408. [0047]In an operation 406, process 400 may include adding the value of the FPS configuration setting to the running configuration if the display-in-config setting is enabled. If the display-in-config setting is not enabled, then the value of the FPS configuration setting is not added to the running configuration.

In an operation 408, process 400 may include displaying the running configuration in response to the configuration listing request.

The systems, methods, and computer readable storage media may facilitate various advantages. Entities using the system may be able to ascertain the FPS configuration setting in the running configuration of network devices. Furthermore, entities may be able to remotely disable or enable the FPS security configuration setting and/or the config-to-display setting through a cloud-based NMS without having physically access network devices. The foregoing technical improvements reduce operational expenses for the entity. Furthermore, usability and security are improved. For instance, an ability to clear passwords and take control of a network device can be disabled, while retaining the flexibility to enable this and other manually actuated control functions.

Although illustrated in FIG. 1 as a single component, NMS 120 and network device 140 may each include a plurality of individual components (e.g., computer devices) each programmed with at least some of the functions described herein. In this manner, some components of NMS 120 and/or network device 140 may perform some functions while other components may perform other functions, as would be appreciated. The one or more processors 122, 142 may each include one or more physical processors that are programmed by computer program instructions. The various instructions described herein are exemplary only. Other configurations and numbers of instructions may be used, so long as the processor(s) 122, 142 are programmed to perform the functions described herein.

Furthermore, it should be appreciated that although the various instructions are illustrated in FIG. 1 as being co-located within a single processing unit, in implementations in which processor(s) 122, 142 includes multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 122, 142 may be programmed by one or more additional instructions that may perform some or all of the functionality attributed herein to one of the instructions.

The various instructions described herein may be stored in a storage device 124, 144 which may comprise random access memory (RAM), read only memory (ROM), and/or other memory. The storage device may store the computer program instructions (e.g., the aforementioned instructions) to be executed by processor 122, 142 as well as data that may be manipulated by processor 122, 142. The storage device may comprise floppy disks, hard disks, optical disks, tapes, or other storage media for storing computer-executable instructions and/or data.

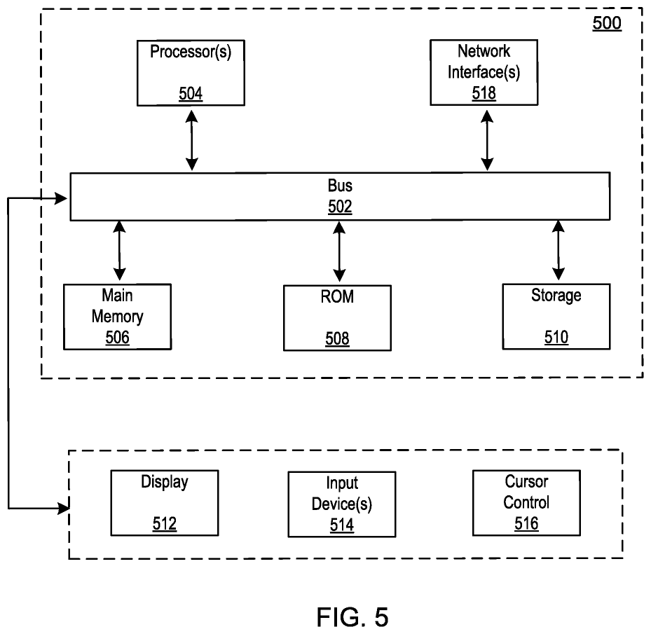

FIG. 5 depicts a block diagram of an example computer system 500 in which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a cathode ray tube (CRT) or LCD display (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 500 may include a user interface component to implement a GUI that may be stored in a mass storage device as executable software codes that are executed by the computing device(s). This and other components may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” as used herein, refers to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors. The components or computing device functionality described herein are preferably implemented as software components, but may be represented in hardware or firmware. Generally, the components described herein refer to logical components that may be combined with other components or divided into sub-components despite their physical organization or storage.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may retrieves and executes the instructions. The instructions received by main memory 506 may optionally be stored on storage device 510 either before or after execution by processor 504.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Other implementations, uses and advantages of the disclosure will be apparent to those skilled in the art from consideration of the specification and practice of the invention disclosed herein. The specification should be considered exemplary only, and the scope of the invention is accordingly intended to be limited only by the following claims.

What is claimed is:

1. A method comprising:
receiving a remotely-initiated request to disable a manually-actuated control function of a user interface member of one or more network devices;
transmitting a command to each of the one or more network devices, wherein the command causes the manually-actuated control function of the user interface member of the one or more network devices to be disabled from being manually actuated; and
maintaining remote control of the manually-actuated control function via a cloud-based network management service.

2. The method of claim 1, wherein the remotely-initiated request is received from an interface of the cloud-based network management service, and wherein the command is transmitted via a web service API call.

3. The method of claim 1, wherein the control function of the user interface member being enabled or disabled is controlled by a front panel security configuration setting of each of the one or more network devices, the method further comprising:
receiving a second remotely-initiated request to enable or disable a config-to-display configuration setting that enables or disables a listing of the front panel security configuration setting in the running configuration of the one or more network device; and
transmitting a second command to each of the one or more network devices, wherein the second command causes the config-to-display configuration setting to be enabled or disabled.

4. The method of claim 3, the method further comprising:
receiving, at a first network device of the one or more network devices, a request to display a listing of the running configuration of the first network device;
determining, at the first network device, whether the config-to-display configuration setting for the first network device has been enabled or disabled;
including or excluding, at the first network device, the listing of the configuration setting in the running configuration based on the determination; and
providing, from the first network device, the running configuration for the first network device responsive to the request to display the listing of the running configuration.

5. The method of claim 1, further comprising:
receiving, at a first network device of the one or more network devices, a request to enable the manually-actuated control function;
denying, at the first network device, the request to enable the manually-actuated control function based on the command.

6. The method of claim 5, further comprising:
receiving a second remotely-initiated request to enable the manually-actuated control function of the user interface member of one or more network devices; and
transmitting a second command to each of the one or more network devices, wherein the second command causes the manually-actuated control function of the user interface member of the one or more network devices to be enabled.

7. The method of claim 1, wherein the one or more network devices comprise at least two network devices that are together remotely configured.

8. The method of claim 1, further comprising:
identifying a plurality of types of network devices, the plurality of types of network devices selected from the group consisting of: a switch, a router, a network controller, an access point, and a gateway;
generating one or more groups of network devices, wherein each group is based on a type of network device; and
generating one or more input options for each group, each input option configured to receive a remotely-initiated request to disable the manually-actuated control function for a respective group.

9. A cloud-based network management system comprising:
one or more processors programmed to:
receive a remotely-initiated request to disable a manually-actuated control function of a user interface member of one or more network devices;
transmit a command to each of the one or more network devices, wherein the command causes the manually-actuated control function of the user interface member of the one or more network devices to be disabled from being manually actuated; and
maintain remote control of the manually-actuated control function.

10. The system of claim 9, wherein the remotely-initiated request is received from an interface of the cloud-based network management service, and wherein the command is transmitted via a web service API call.

11. The system of claim 9, wherein the control function of the user interface member being enabled or disabled is controlled by a configuration setting of each of the one or more network devices, the one or more processors further programmed to:
receive a second remotely-initiated request to enable or disable a listing of the configuration setting in a running configuration of each of the one or more network devices; and
transmit a second command to each of the one or more network devices, wherein the second command causes the listing of the configuration setting in the running configuration to be enabled or disabled.

12. The system of claim 11, further comprising:
a first network device of the one or more network devices programmed to:
receive a request to display a listing of the running configuration of the first network device;
determine whether the listing of the configuration setting in the running configuration for the first network device has been enabled or disabled;
include or exclude, at the first network device, the listing of the configuration setting in the running configuration based on the determination; and
provide the running configuration for the first network device responsive to the request to display the listing of the running configuration.

13. The system of claim 9, further comprising:
a first network device of the one or more network devices programmed to:
receive a request to enable the manually-actuated control function;
deny the request to enable the manually-actuated control function based on the command.

14. The system of claim 13, the one or more processors further programmed to:
receive a second remotely-initiated request to enable the manually-actuated control function of the user interface member of one or more network devices; and
transmit a second command to each of the one or more network devices, wherein the second command causes the manually-actuated control function of the user interface member of the one or more network devices to be enabled.

15. The system of claim 9, wherein the one or more network devices comprise at least two network devices that are together remotely configured.

16. The system of claim 9, the one or more processors further programmed to:
identify a plurality of types of network devices, the plurality of types of network devices selected from the group consisting of: a switch, a router, a network controller, an access point, and a gateway;
generate one or more groups of network devices, wherein each group is based on a type of network device; and
generate one or more input options for each group, each input option configured to receive a remotely-initiated request to disable the manually-actuated control function for a respective group.

17. A computer readable storage medium comprising instructions, when executed on a network device, programs the network device to:
receive an indication of a manual actuation of a user interface member of the network device;
determine that the manual actuation corresponds to a manually-actuated control function;
consult a front panel security configuration setting that enables or disables the manually-actuated control function;
determine that the manually-actuated control function is disabled based on the front panel security configuration setting; and
not perform the manually-actuated control function responsive to the determination that the manually-actuated control function is disabled.

18. The computer readable storage medium of claim 17, the instructions further programming the network device to:
receive a command from a cloud network management system, the command instructing the network device to enable the manually-actuated control function;
update the front panel security configuration setting to enable the manually-actuated control function;
receive a second indication of the manual actuation of the user interface member of the network device at a second time;
determine that the manual actuation corresponds to the manually-actuated control function;
consult the front panel security configuration setting;
determine that the manually-actuated control function is enabled based on the front panel security configuration setting; and
perform the manually-actuated control function responsive to the determination that the manually-actuated control function is enabled.

19. The computer readable storage medium of claim 17, the instructions further programming the network device to:
receive a request to display a listing of the running configuration of the network device;
determine whether the listing of the configuration setting in the running configuration for the network device has been enabled or disabled;
include or exclude the listing of the configuration setting in the running configuration based on the determination; and
provide the running configuration for the network device responsive to the request to display the listing of the running configuration.

20. The computer readable storage medium of claim 19, the instructions further programming the network device to:
receive a command from a cloud network management system, the command instructing the network device to disable a config-to-display configuration setting that enables or disables a listing of the front panel security configuration setting in the running configuration for the network device;
update the config-to-display configuration setting to disable the listing of the front panel security configuration setting in the running configuration.
